(19) United States
(12) Patent Application Publication
(10) Pub. No.: US 2025/0162916 A1
(43) Pub. Date: May 22, 2025

(54) FLOATING WETLANDS

(71) Applicant: National Aquarium, Inc., Baltimore, MD (US)

(72) Inventors: John Franklin Cover, JR., Fallston, MD (US); Paul Gregory Valiquette, Towson, MD (US); Charmaine Marie Dahlenburg, Baltimore, MD (US)

(21) Appl. No.: 18/517,904

(22) Filed: Nov. 22, 2023

(51) Int. Cl. C02F 3/32

(52) U.S. Cl. CPC C02F 3/327

(57) ABSTRACT

Floating wetland systems can include: decking; PET layers mounted on the decking; a plurality of pontoons coupled to the decking, each of the pontoons defining a hollow interior space and having a discharge port located on a side of the pontoon away from the decking and an inlet port; and piping connecting the inlet port to a compressed air system and a second discharge port.

### TECHNICAL FIELD

This specification relates to artificial wetlands.

### BACKGROUND

Floating wetlands are typically small, constructed rafts that provide areas for wetland plants to grow in water that is otherwise too deep for them. Roots of the plants grow down into the water. The plants can take up excess nutrients and contaminants and also provide submerged surface areas to support the growth of ecologically beneficial biofilms.

### SUMMARY

This specification describes systems and methods of providing sustainable floating wetlands. This approach includes a floating wetland with a skeleton formed of inert plastic materials. An adjustable buoyancy system provides a mechanism for counteracting the addition of weight from accumulating biomass. The floating wetlands provide habitat for wetland plants and animals. The floating wetlands also improve water quality through the uptake and sequestration of excess nutrients (i.e., nitrogen and phosphorus) and pollutants in the water column.

Implementations of this approach can include layers of polyethylene terephthalate/plastic (PET) mesh providing a substrate for native salt marsh plants and submerged surfaces for biofilm growth. Airlift pipes provide water flow through shallow channels of the floating wetlands simulating the moving tidal waters in natural shallow channel microhabitats found in traditional tidal salt marshes. Some systems include additional aeration systems under and around the floating wetlands mixing and destratifying the water column as well as increasing dissolved oxygen levels in the water column.

The systems and methods described in this specification can promote improvements in water quality and provide shallow water habitat for native aquatic species. This can include providing refuge for small fish and newly molted crabs; forage habitat for fish, aquatic invertebrates, reptiles and birds; and a food source for insects. In addition, wetland plants provide spawning and egg laying habitat for small fishes and nursery habitat for fish and aquatic invertebrates. The floating wetlands can remove nitrogen from the water through the associated bacterial biofilms and support the growth of native tidal marsh plants within the wetlands. These plants have submerged roots taking up nutrients directly from the water and reduce the nitrogen in the water column lessening the likelihood of an algal or bacterial bloom. Additional nutrient and sedimentation removal is provided by living filter feeding organisms inhabiting the shallow channel habitat and colonizing the submerged hard surface areas of the floating wetlands. These include oysters, mussels, and barnacles.

Unlike other floating wetlands designs, the approach described in this specification allows for adjustable buoyancy by adding air to pontoons located below the surface. Adjustable buoyancy allows for precise maintenance of the submergence level of the floating wetlands for maximum growth and long-term survival of wetland plants and optimal flow of water from the airlift pipes. Having the components needed to raise the floating wetland above the surface of the water also makes long-term maintenance easier. This design utilizes a minimal amount of injectable marine foam to hold PET layers together and not for buoyancy. This allows a greater utilization of PET matrix material for planting and much larger quantity of PET surface area for colonization of biofilms that will then remove greater quantities of excess nutrients, pollutants, and sediments from the water column. In contrast, buoyancy in typical floating wetlands using layers of PET mesh material as a planting media is provided by expanding marine foam injected at various locations throughout the layered mat of PET. Marine foam provides both buoyancy and binds the PET layers together. This results in fixed buoyancy that keeps the upper layers of PET above the surface water at a desired level. Nursery grown wetland plants are planted in planter holes cut into the PET layers. Overtime biomass, in the form of wetland plants and aquatic organisms that settle and grow on hard surfaces below the waterline, add weight to the floating wetland causing it to sink deeper into water. Weight from biomass growth and accumulation can result in complete submergence of the constructed wetland below the target buoyancy level.

The airlift pipe design provides an efficient and low-cost method of moving large volumes of water to keep water moving in the floating wetlands' shallow channel to mimic the tidal water movement in the shallow channel habitat of a natural tidal saltmarsh. The flow of harbor water containing natural levels of plankton provides an ample food source for filter feeding organisms that include barnacles, dark false mussels, ghost anemones and bryozoans that heavily colonize the inner surfaces of the pipe. These organisms eventually occupy the inner surfaces of the airlift pipes reducing the diameter and creating friction that reduces the flow rate through the pipe. Marine debris (e.g., plastic bags) can also enter the airlift pipes and reduce flow. To maintain flow, the entire fouled airlift pipe is removed 2-3 times a year and replaced with a clean airlift pipe. Airlift pipe removal involves loosening a hose ring fitting and disconnecting the rubber compress air supply hose. Two flexible straps hold the airlift in the receiver “saddle”. These hold-down straps are lifted off the top of the airlift and moved to the side. The airlift pipe is now untethered and lifted out of the receiver. A clean airlift pipe replacement is then installed into the receiver. Hold down straps are moved to strap down the clean airlift and the compressed airline hose is reattached to the airlift's barb fitting. Flow rate out of the pipe is adjusted via globe valve if needed.

Utilizing airlifts and compressed air rather than pumps with submerged propellers can provide significant advantages in artificial wetland applications. Airlifts and compressed air can be used to move large volumes of water, at a lower cost, when compared to submersible pumps with propellers. Airlifts are typically more durable with no metal parts to corrode and are less prone to clogging from debris. Perhaps most significant in floating wetland applications, airlifts are much safer for aquatic life than propeller drive devices used to move water. For example, small fish and aquatic invertebrates drawn into an airlift pipe will pass through it unharmed. The same small fish or invertebrates drawn into a propeller driven device could be injured or be killed by the propellor or held tapped against a strainer screen located upstream of the propeller.

Space for green infrastructure is typically unavailable in waterfront cities. This durable floating wetland design provides the option of locating green infrastructure out in the open water where ample space is available. Large-scale floating wetlands not only provide aesthetic value to waterfront cities but can also help to restore ecological function and free services to help improve water quality in post-industrial impaired waters. Floating wetlands can be utilized as teaching tools and provide wildlife watching opportunities to urban dwellers, workers, and visitors.

Traditional floating wetlands sit at the surface of the water and consist of a buoyant mat designed to remain afloat and move with the water's surface. They are not intended to support human weight and not built to be sturdy enough for people to stand on, limiting accessibility for maintenance and recreation. This specification uses a grating material that provides durability and is capable of supporting human weight. This type of construction makes the floating wetlands more robust and suitable for human use, distinguishing it from traditional floating wetlands designed primarily for ecological purposes. The grating material adds structural integrity, making it a stable platform for various maintenance activities and potentially increasing its versatility.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a floating artificial wetland.

FIG. 2 is a plan view illustrating decking of the floating artificial wetland of FIG. 1.

FIG. 3 is a plan view of the floating artificial wetland of FIG. 1.

FIG. 4 is a cross-sectional view of the floating artificial wetland of FIG. 1.

FIG. 5A and FIG. 5B are cross-sectional views illustrating pontoons supporting the decking and mesh layers disposed on the decking of the floating artificial wetland of FIG. 1

FIG. 6A and FIG. 6B are, respectively, a plan view and a cross-sectional view of a module of the floating artificial wetland of FIG. 1.

FIG. 7A, FIG. 7B, and FIG. 7C are, respectively, a cross-section view, a front view, and a top view of an airlift assembly.

FIG. 8 illustrates the process of removing an airlift assembly from a receiver mounted on the decking.

FIG. 9A and FIG. 9B illustrate an air portal assembly.

FIGS. 10A-10D illustrate use of the adjustable buoyancy system.

Like reference symbols in the various drawings indicate like elements.

### DETAILED DESCRIPTION

This specification describes systems and methods of providing sustainable floating wetlands. This approach includes a floating wetland with a skeleton formed of inert plastic materials. An adjustable buoyancy system provides a mechanism for counteracting the addition of weight from accumulating biomass. The floating wetlands provide habitat for wetland plants and animals. The floating wetlands also improve water quality through the uptake and sequestration of excess nutrients (i.e., nitrogen and phosphorus) and pollutants in the water column.

Implementations of this approach can include layers of PET mesh providing a substrate for native salt marsh plants and submerged surfaces for biofilm growth. Airlift pipes provide water flow through shallow channels of the floating wetlands simulating the moving tidal waters in the natural shallow channel microhabitats found in tidal salt marshes. Some systems include additional aeration systems under and around the floating wetlands mixing and destratifying the water column as well as increasing dissolved oxygen levels in the water column.

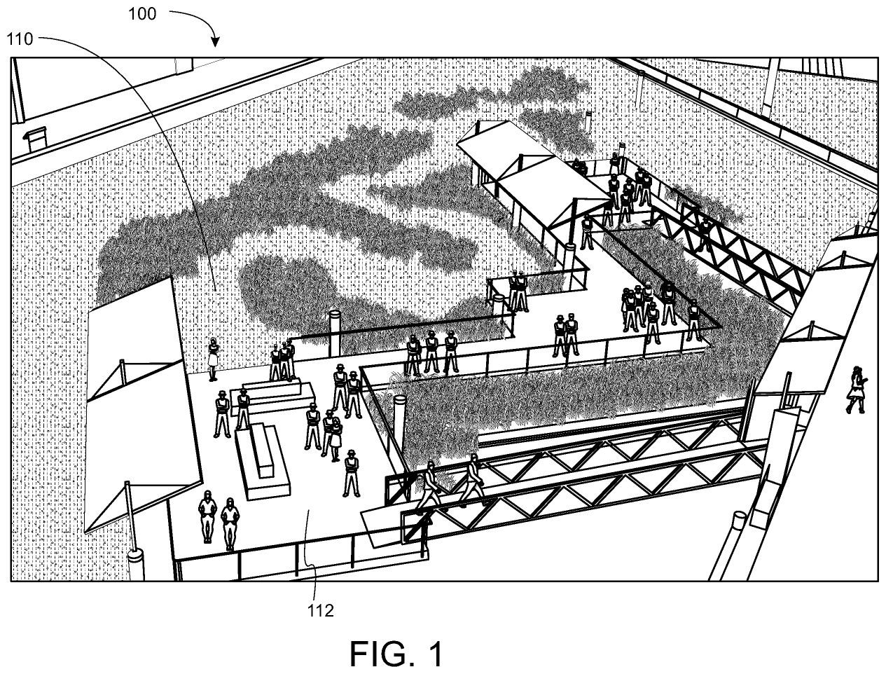

FIG. 1 is a perspective view of a floating artificial wetland 100. The floating wetland 100 includes five separate islands defining a curved central channel 110 that mimics a natural marsh shoreline. The floating artificial wetland 100 includes a floating dock 112 extending from shore to provide access for visitors. Although floating docks can provide access for educational and recreational purposes, implementations of floating artificial wetlands configured primarily for water treatment and habitat purposes usually do not include docks. For example, the integration between deck and wetlands provides an organic connection between the adjacent shoreline and the water. This connection provides aesthetic advantages and the opportunity connect the local population more closely with a harbor where floating wetlands are installed (e.g., via rental of paddle boats, canoes, and kayaks, outdoor dining, and event space.

Emergent marsh grasses of tidal wetlands have been documented to absorb wave energy and protect shorelines from storm damage and erosion. Constructed floating wetlands also absorb wave energy and can protect shorelines.

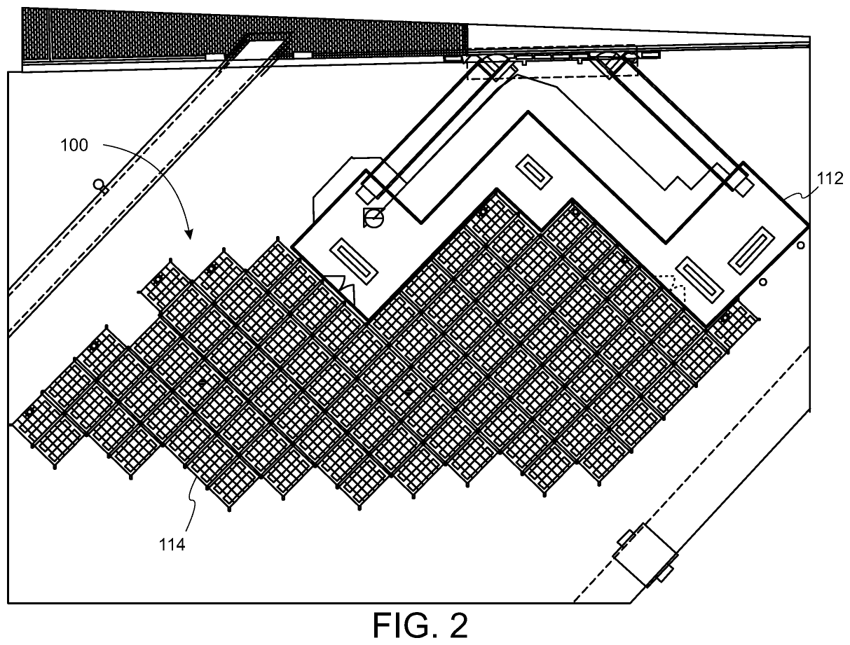

FIG. 2 is a plan view illustrating the two pontoon modules connected together to make the primary structural feature of the floating artificial wetland 100. A continuous deck of 2″×2″ open cell FRP panels are attached to the connected modules. The FRP decking is chosen to provide a sufficiently rigid base to support PET layers and reserve buoyancy blocks with foot traffic without being damaged. For example, some wetlands are designed to locally support 40 pounds per square foot of personnel loading.

In a proposed prototype, the decking 114 will be formed of a 2-inch-thick fiberglass grating. The grating is environmentally inert, and provides the base to which the PET layers are fastened and stainless steel threaded support rods are attached. This material is strong enough to withstand the catastrophic loss of a pontoon's buoyancy without structural failure.

The decking 114 is provided in modules (e.g., rectangular modules) with the decking 114 mounted on top of pontoons (not shown) that support the floating artificial wetland 100 near the water surface. The modules are attached at abutting corners with fittings robust enough to survive anticipated environmental impacts. For example, the prototype wetland uses 316 grade stainless steel bolts to attach HDPE pontoon tabs to the synthetic lumber support structure and FRP open cell decking. The decking is held in place by pilings (e.g., steel pipe piles) extending through collars attached to the decking. The pilings are designed to accommodate FEMA 100-year flood levels by having pilings tall enough to allow the decking to rise to flood levels without floating off. This construction is designed to resist winds, waves, and currents from a 100-year storm with a service life of 30 years with low maintenance.

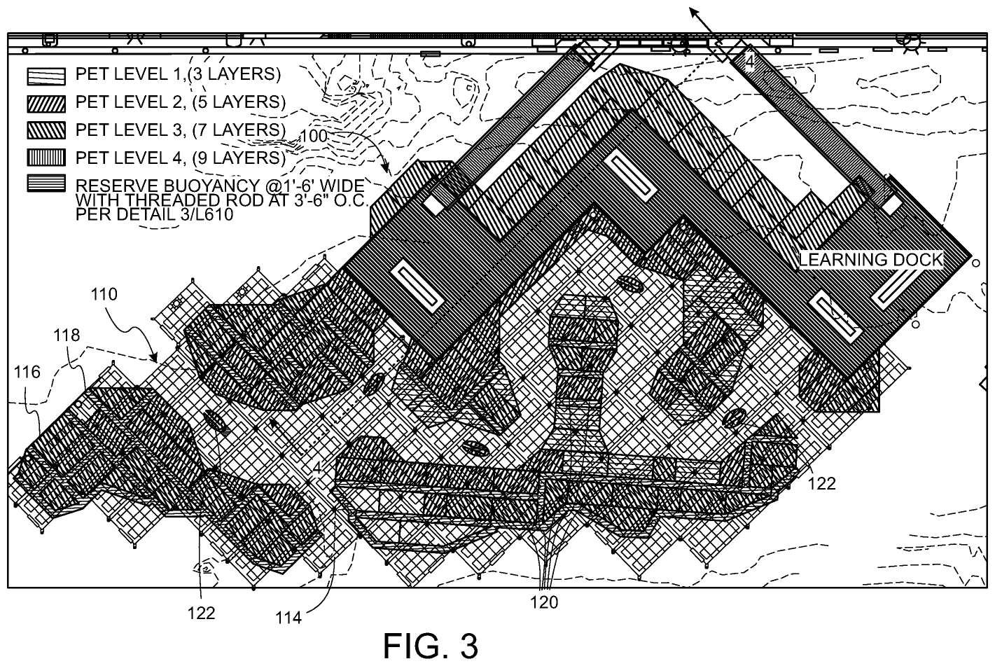

FIG. 3 is a plan view of the floating artificial wetland 100. The number of PET layers 116 mounted on the decking 114 varies with location to provide elevation changes that accommodate a variety of high and low marsh shrubs and grasses. The PET layers 116 define the boundaries of the central channel 110. No PET layers 116 are attached to decking 114 along the route of the central channel 110.

The floating artificial wetland 100 also includes a reserve flotation system engineered for added buoyancy and stability. The reserve flotation system is provided by buoyant material located above the normal waterline of the wetland. When additional weight is added to the surface of the wetland (e.g., due to people walking on the wetland or wave action), the reserve buoyancy material starts to submerge and provides a counterbalancing lift.

The center channel 110 has moving water that mimics the tidal movement of shallow-water habitat for native wildlife. Flow in the center channel 110 is generated by airlift assemblies 120 positioned along the central channel with their discharges (indicated by the arrows extending the airlift assemblies 120) oriented along the central channel 110.

An additional aeration system, air stones dropped through openings (air portals) assemblies 122 complement the flow generated by the airlift assemblies 120. The air portal assemblies 122 are connected to a blower (not shown) and discharge air bubbles mix and destratify the water column and also increase dissolved oxygen levels in the water. Constant up flow of water from the rising bubbles generated from these air stones actively delivers excess nutrients in the harbor water to marsh plants planted in planter holes in the PET. Suspended fine sediments are transported to sticky biofilms growing on the PET material, emergent roots and submerged surfaces of the floating wetlands structure.

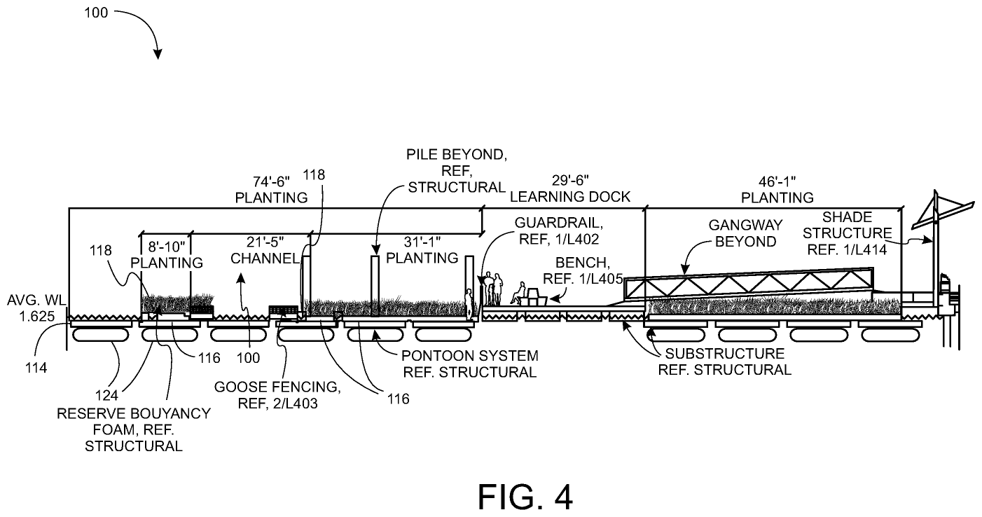

FIG. 4 is a cross-sectional view of the floating artificial wetland 100 taken along line 4-4 in FIG. 3. This figure further illustrates some of the features already discussed with reference to FIGS. 1-3. The decking 114 is supported by pontoon structures connected to module frame supports 122. In the central channel 110, a layer of oyster shells and live oysters cover the decking 114. Vegetation is planted in holes cut into the upper PET layers 116. In this view, various levels of PET are represented mimicking low marsh and high marsh habitats 114 are present.

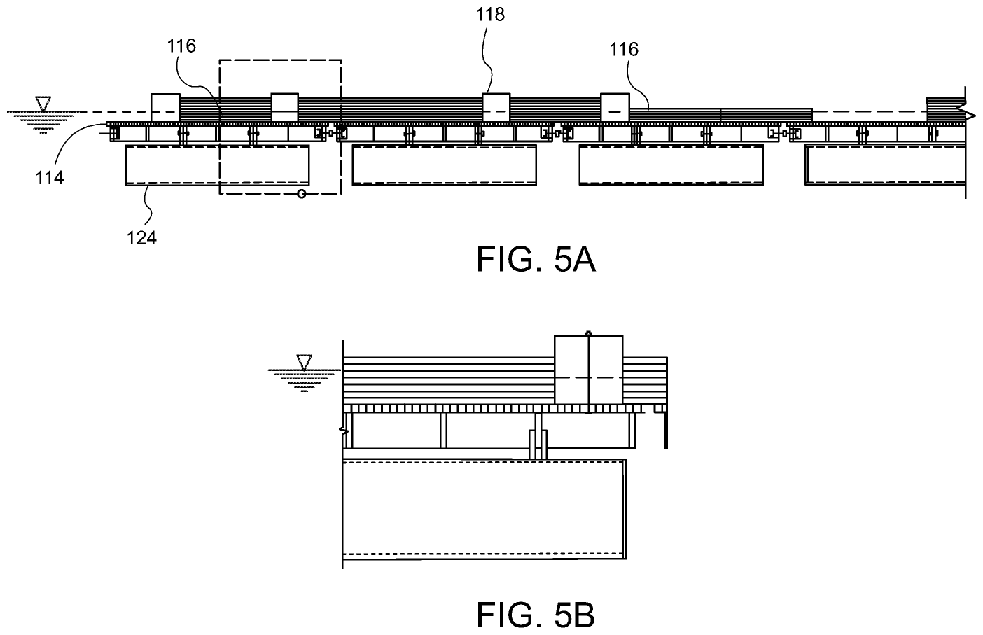

The pontoons 124 (shown in more detail in FIGS. 5A-5B) are connected to the aeration system incorporating the air portal assemblies 122. For example, the prototype wetland 100 will include air supply lines running from the blower (not shown) to the pontoons 124 and the air portal assemblies 125. The air supply lines will run along the underside of the decking in places and on top of the decking in other locations 114 and be strap-tied to the decking. The air supply is controlled using manually adjusted globe valves connected to the modules. These connections provide a mechanism to control the buoyancy of each module's pontoons 124 and the overall wetland 100. For example, the buoyancy of the wetland can be increased periodically to compensate for the gradual increase of biomass in the wetland. The controllable ballast system allows for regular buoyancy adjustments to counteract the effects of added marine and terrestrial plant growth weight. This approach provides stability in spite of the low freeboard required by the plantings in which the highest marsh levels only extend 6 inches above water. The design of the prototype is based on an estimated fouling load of 1.5 pounds per square foot per year. It is anticipated that the increase in fouling will gradually taper off to near zero within 10 years.

FIG. 5A and FIG. 5B are cross-sectional views illustrating pontoons supporting the decking and mesh layers disposed on the decking of the floating artificial wetland 100. The controllable ballast system utilizes high-density polyethylene (HDPE) 30-inch diameter pontoons with adjustable water fill, referred to as the “dynamic buoyancy” system. The floating wetland is designed to easily accommodate additional pontoons being floated under the wetland, attached, and then pumped full of air to provide supplemental buoyancy.

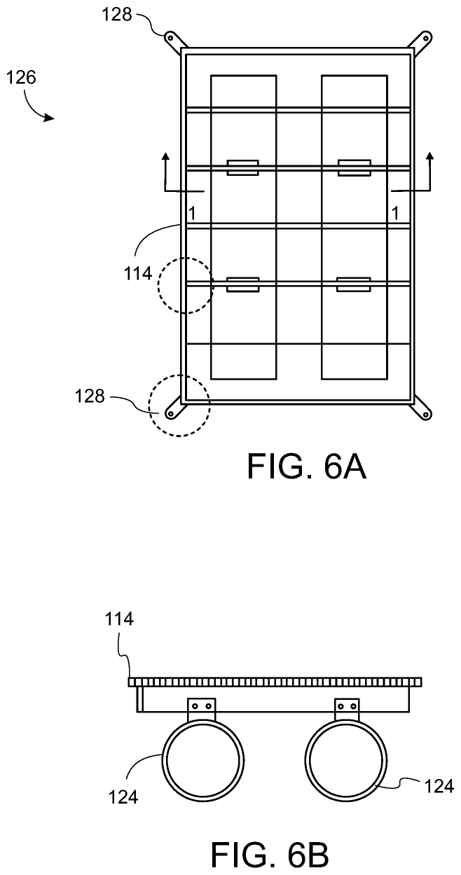

FIG. 6A and FIG. 6B are, respectively, a plan view and a cross-sectional view of a module 126 of the floating artificial wetland 100. The modules 126 include the decking 114 mounted on the pontoons 124. The modules 126 include padeyes 128 at each corner. The modules 126 arrive onsite with sufficient buoyancy to keep the decking 114 raised out of the water. The modules 126 are attached to each other using fasteners inserted through overlapping padeyes 128. The compressed air supply lines are run both under and above decking 114 after attaching the modules to each other. The airlifts, air diffusers, air portals, and compressed air supply hoses and valves are completed with the wetland at this level. Planting, installation of waterfowl exclusion fencing, and addition of oyster shell occurs after the pontoons are flooded to sink the wetland 110 to its designated depth and freeboard. A layer of oyster shell with live juvenile oysters (called spat) growing on them and naked oyster shell will be placed over the open cell FRP deck of the shallow channel.

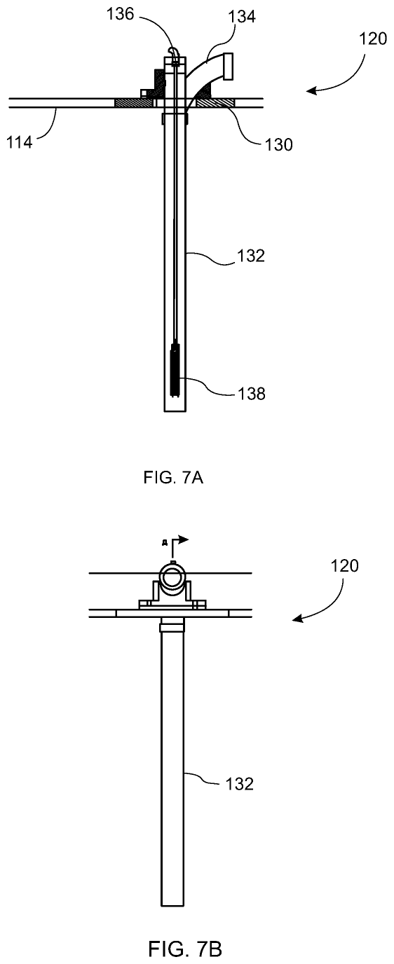

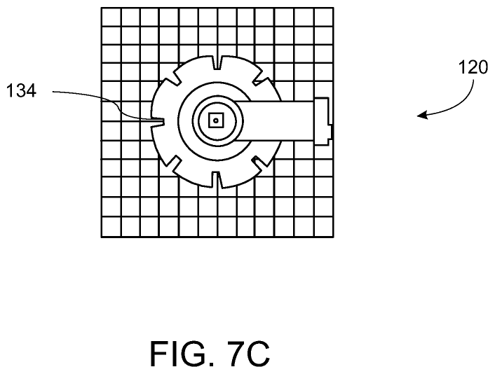

FIG. 7A, FIG. 7B, and FIG. 7C are, respectively, a cross-section view, a front view, and a top view of the airlift assembly 120. The airlift assembly 120 has a body including a length of pipe 132 attached to a tee wye fitting 134. The end of the pipe 132 opposite the tee wye filling 134 is open. The upper end of the tee wye fitting 134 is sealed and the lateral end is open. Air supply tubing is connected to a valve 136 at the sealed end of the tee wye fitting 134. Air supply tubing connected to a bubbler 138 is disposed in the body of the airlift assembly 120. The airlift assembly 120 is sized such that the open lateral end of the tee wye fitting is mostly below the design waterline of the wetland when the airlift assembly 120 is installed in the receiver 130.

In operation, the valve 136 is opened to allow air from the blower to flow down the internal air supply tubing to the bubbler 138. Air released from the bubbler 138 rises in the pipe 132 pulling water into the pipe 132 through the open end at its bottom. Because the upper end of the tee wye fitting 134 is sealed and the lateral end is open, the air and entrained water flow out the airlift assembly 120.

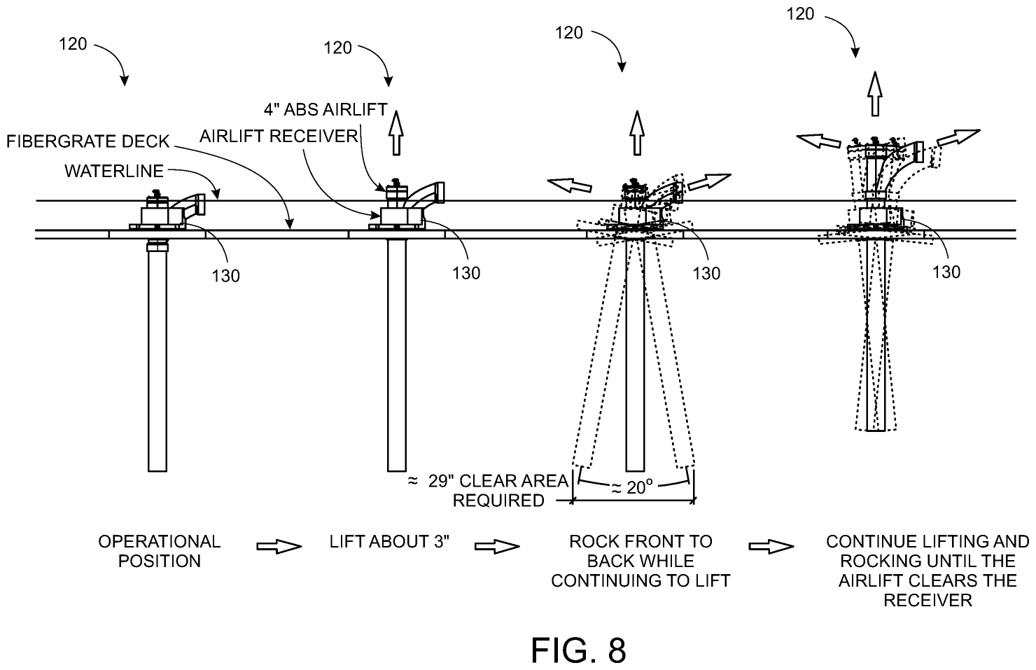

FIG. 8 illustrates the process of removing an airlift assembly 120 from a receiver 130 mounted on the decking 114. Periodically, it may be necessary to remove the airlift assemblies 120 from the wetland when the interior airlift pipe is befouled with barnacles, dark false mussels, bryozoans and marine debris (e.g., plastic bags) that are reducing flow. The exterior surfaces of the airlift pipes are also colonized by barnacles, dark false mussels and bryozoans making it difficult to pull the airlift pipe through the airlift hole opening in the deck. To remove the airlift assembly 120, a mechanical advantage puller (e.g., a lever with a quick attachment fitting) is used to lift the airlift assembly about 3 inches. The operators continue to lift the airlift assembly 120 while rocking it front to back (i.e., aligned with the direction the lateral end of the tee wye is oriented). This lifting and rocking are continued until the airlift assembly clears the receiver 130. The mechanical advantage puller provides the force necessary initially break the fouling between the receiver and the tee wye and, at the end of the extraction, to pull a cone of fouling at the bottom of the airlift pipe through the receiver.

The airlift pipe is typically ABS foam-cored piping rather than regular PVC piping. The ABS foam-cored piping is lighter than regular PVC piping and floats if is dropped in the water.

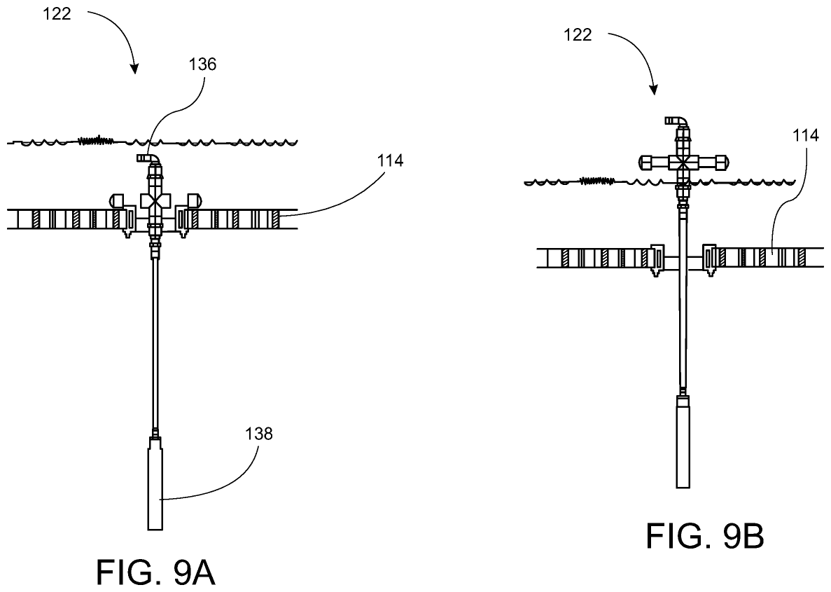

FIG. 9A and FIG. 9B illustrate an air portal assembly 122. The air portal assembly 122 is similar to the airlift assembly in including a valve 136 connected to a bubbler 138 by air supply tubing. The primary difference is that the air portal assembly 122 does not include a body extending around the bubbler 138 and air supply tubing. In operation, the valve 136 is opened to allow air from the blower to flow down the internal air supply tubing to the bubbler 138. Air released from the air stone bubbler 138 rises entraining water but, in the absence of the pipe and the sanitary sweep tee fitting of the airlift assembly, does not impart a lateral component to the flow. The upwelling created by rising bubbles delivers excess nutrients, pollutants and fine suspended sediments up to plant roots and biofilms growing in the PET layers. This creates active, more efficient, uptake and removal of excess nutrients, pollutants and fine sediments from the harbor water. A PVC pipe tee fitting 112 is used keep a ceramic air stone 138 at a desired elevation in the water column, FIG. 9B-Air stone assemblies are cleaned of biofouling periodically by pulling the air supply hose and air stone up and out of the water through the air portal opening.

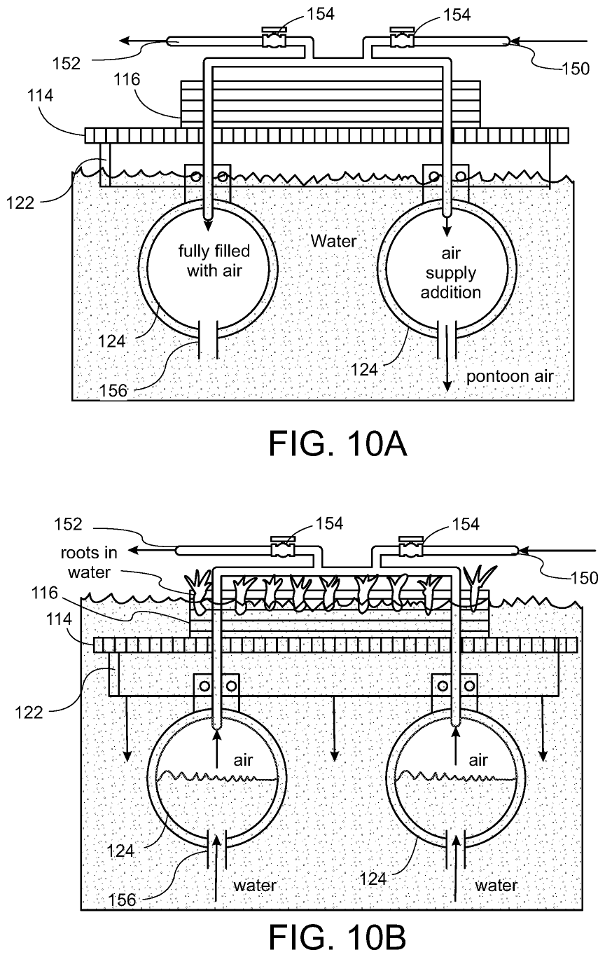

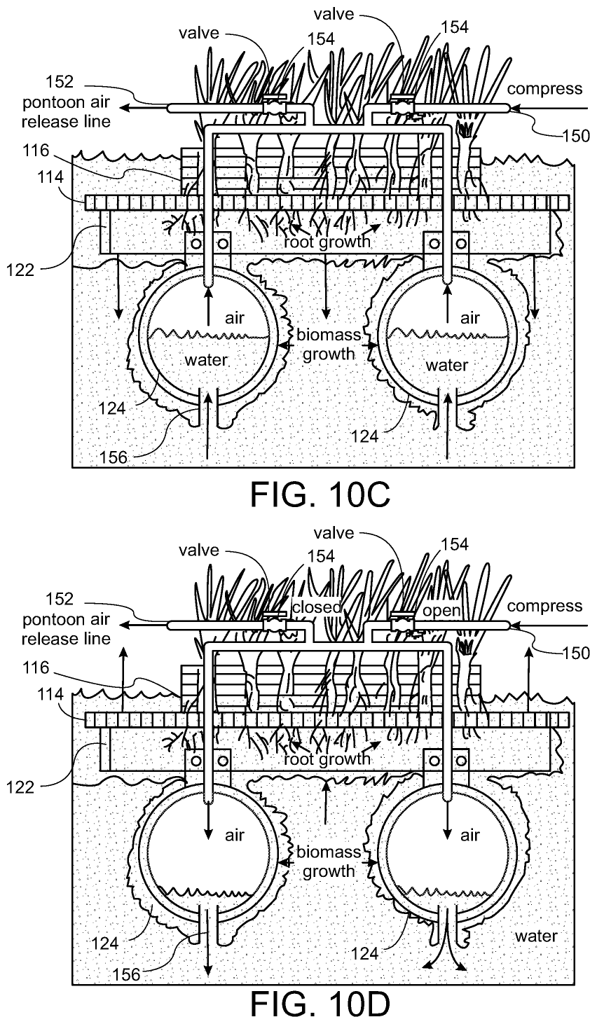

FIGS. 10A-10D illustrate use of the adjustable buoyancy system. As previously described, the decking 114 is attached to the pontoons 124 by the frames 122. The PET layers 116 are mounted on the decking 114. A compressed air line 150 and an air bleed-off line 152 are connected to a hollow space inside the pontoons 124. The flow of air through the compressed air line 150 and the air bleed-off line 152 is controlled by valves 154. A port 156 in the bottom of the pontoons 124 allows water to enter the pontoon when the valve 154 in the compressed air line 150 is closed and the valve 154 in the air bleed-off line 152 is open. Conversely, water and, in some cases, air is discharged through the ports 156 when the valve 154 in the compressed air line 150 is open and the valve 154 in the air bleed-off line 152 is closed.

Typically, the pontoons 124 are fully filled with air as artificial wetlands are being constructed (FIG. 10A). In this configuration, the artificial wetlands are at their maximum elevation. After construction, the valve 154 in the air bleed-off line 152 is opened allowing air to bleed-off and water to enter the pontoons 124 until the target submergence level is reached (FIG. 10B). Typically the plantings in the PET layers 116 are completed before the wetlands are lowered to their target submergence level but plantings and/or re-plantings can be completed with the wetlands at their target submergence level. At the target submergence level, the roots of the plantings are in contact with the water supporting the floating wetlands. Over time, the biomass (i.e., the plantings, biofilms, etc.) supported by the floating wetlands increases and lowers the floating wetlands in the water column (FIG. 10C). Periodically, the floating wetlands are raised back to the target submergence level by opening the valve 154 in the compressed air line 150 to add air to the pontoons 124.

### Other Applications

The airlift assembly, airlift receiver, and buoyancy deck (or tank attachment) can be used for emergency deployment in closed water systems (e.g., aquarium settings) that support aquatic life. Aquarium institutions are required to have emergency backup aeration in the event of power loss. The airlift and airlift receivers as a standalone unit allow for quick deployment as a source of emergency aeration to maintain suitable dissolved oxygen levels and water circulation to sustain aquatic life.

The airlift assembly, airlift receiver, and buoyancy deck can also be used as a water mixing device. A buoyant or fixed airlift could be used in mixing tanks to get solid materials into solution and maintain water at a desired temperature (e.g., by reducing temperature stratification). For example, this airlift design could be used to in the making of large quantities of artificial seawater for aquarium use, by actively drawing bottom water and added salt mixes up from the bottom and into surface water. This application can create active liquid circulation to get solids mixed into liquids more rapidly. It can also be used to maintain a uniform target temperature in a circular tank by constantly circulating water over a submersible heater set at a target temperature.

The airlift, airlift receiver, decking, and pontoon buoyancy system can be applied as a submerged shallow deck for use in habitat restoration projects or aquaculture. Submerged aquatic vegetation (SAV) beds and coral reef habitats have specific depth requirements to remain within the photic zone in order to perform photosynthesis. Oyster reef habitat requires a depth that keeps oysters submerged during a typical tide cycle for peak performance. The dynamic buoyancy allows control of where a submerged decking platform sits within the water column while the airlift/airlift receiver delivers nutrients and food (plankton) to filter feeding organisms like oysters, accelerating their growth. This system can be used to grow SAVs, coral, and oysters for use in the restoration of SAV beds, oyster reefs and coral reef habitats. It can also be used for more rapid growth of oysters and other bivalves for commercial harvest in floating enclosures. Fish spawning habitats (gravel/sand beds, aquatic vegetation, submerged stick piles) may be recreated in impaired highly altered waterways where spawning habitats no longer exist using this floating wetlands system.

The airlift, airlift receiver, decking, and pontoon buoyancy system can also be used for mitigation of anoxic water conditions. The airlift technology can be applied to pull unoxygenated water from desired depth, oxygenate, then circulate oxygenated water back to desired depth. This process promotes destratification of the water column which negatively leads to the formation of harmful algae blooms.

The full floating wetland system can be used to enhance the traditional (without aeration) floating wetlands with the addition of buoyancy control and active vs. passive nutrient removal in stormwater retention ponds. The movement of water enhances the denitrification process by actively feeding beneficial bacterial biofilms and increased uptake rate by live plants. This approach can also be used to enhance aquaculture practices used for raising fish and oyster production. The floating wetland system increases fish and oyster biomass and growth rate through habitat enhancement for aquaculture purposes. It can also be used for hydroponic enhancement to increase production and accelerate growth rates for hydroponically grown vegetables for human consumption. Nutrients and waste matter that have settled on or near the bottom are actively transported to the roots of plants for more rapid uptake.

The system as described with reference to FIGS. 1-9B can be supplemented with a battery, solar powered charger, and a DCV air pump to create a remotely deployable and self-contained aeration/circulation device. In some implementations, buoyancy can be provided by air filled PVC pipe rings with PET mats located in the interior space and attached to the floating rings. are used instead of pontoons below decking.

A number of embodiments of the systems and methods have been described. Nevertheless, it will be understood that various modifications may be made without departing from the spirit and scope of this specification. Accordingly, other embodiments are within the scope of the following claims.

What is claimed is:

1. A floating wetland system comprising:
decking;
PET layers mounted on the decking;
a plurality of pontoons coupled to the decking, each of the pontoons defining a hollow interior space and having a discharge port located on a side of the pontoon away from the decking and an inlet port; and
piping connecting the inlet port to a compressed air system and a second discharge port.
